(19) United States
(12) Patent Application Publication
(10) Pub. No.: US 2026/0211705 A1
(43) Pub. Date: Jul. 23, 2026

(54) OPERATING SYSTEM WITH CONTENT HOLDING LAYER

(71) Applicant: Microsoft Technology Licensing, LLC, Redmond, WA (US)

(72) Inventor: Vamsikrishna NUKALA, Hydreabad (IN)

(73) Assignee: Microsoft Technology Licensing, LLC, Redmond, WA (US)

(21) Appl. No.: 19/033,017

(22) Filed: Jan. 21, 2025

(51) Int. Cl. G06F 9/451; G06F 3/0482; G06F 3/0484

(52) U.S. Cl. CPC G06F 9/451; G06F 3/0482; G06F 3/0484

(57) ABSTRACT

A system for providing a content holding layer includes a processing system and memory storing instructions that, when executed by the processing system, cause the system to display a content holding element on a desktop of an operating system, receive an input for adding a content item to the content holding element, obtain content item data of the content item, add the content item data to a database associated with the content holding element, display a content holding application on the desktop, display a representation of the content item in the content holding application, determine one or more recommended actions applicable to the content item based at least in part of the content item data, and display, one or more selectable elements for executing the one or more recommended actions.

### BACKGROUND

Operating systems of computing devices, such as personal computers and tablets, store and manage files of many kinds. Some operating systems may provide a desktop surface, which provides a visual interface for interacting with the computing device. The desktop may be configured to provide access to various applications of the operating system as well as content stored in memory, such as various types of files. Files are commonly stored in a hierarchical structure of folders across one or more drives, which can be virtual or physical storage locations. Due to the large amount of content that can be stored on a computing device and the limited amount of visual real estate, the functionality of computing devices can be improved by providing ways to organize content and facilitate efficient execution of the functions of the computing devices.

It is with respect to these and other considerations that examples have been made. In addition, although relatively specific problems have been discussed, it should be understood that the examples should not be limited to solving the specific problems identified in the background.

### SUMMARY

This summary is provided to introduce a selection of concepts in a simplified form that are further described below in the Detailed Description section. This summary is not intended to identify key features or essential features of the claimed subject matter, nor is it intended as an aid in determining the scope of the claimed subject matter.

The present technology relates to systems and methods that implement a content holding layer. A content holding layer may be implemented on a computing device as a content holding application of the operating system. The content holding application may be accessed via a content holding application surface. The content holding surface may further include interfacing components such as a content holding element and a content holding application window. In some embodiments, the content holding layer may be implemented via other means that provide substantially similar functions as those presented herein.

In some embodiments, a content holding surface may be provided on a desktop of a computing device, to which content items such as files, text, images, and the like may be added. For example, a content item may be added to the content holding application surface via a drag action, click, hotkey, voice command, gesture, or other input. The content holding surface may display a list of the content items that have been added. The content holding surface may also display one or more recommended actions that can be executed on or applied to one or more of the content items in the content holding application surface. The recommended actions are intended to anticipate the user's intent. In some embodiments, the one or more recommended actions are determined based at least in part on the content type of the one or more content items in the content holding application surface. In some embodiments, the recommended actions are determined based at least in part on various contextual information related to the computing device such as current and recently opened applications, content of the content items, content in other applications, and historical user behavior including previously or recently executed actions. In some embodiments the recommended actions are determined based on applying a machine learning model to the contextual information. The one or more recommended actions may be displayed as selectable options in the content holding application surface. Accordingly, a user input may be received indicating a selection of one of the recommended actions. The selected action may then be executed or applied to the one or more content items in the content holding application surface.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF THE DRAWINGS

The accompanying drawings, which are incorporated in and constitute a part of this disclosure, illustrate various aspects of the present invention. In the drawings:

FIG. 1A depicts an example desktop interface with a content holding application.

FIG. 1B depicts the example desktop interface with the content holding application in a first state.

FIG. 1C depicts the example desktop interface with the content holding application in a second state.

FIG. 1D depicts the example desktop interface with the content holding application in a third state.

FIG. 1E depicts the example desktop interface with the content holding application in a fourth state.

FIG. 2 depicts an example system for implementing a content holding layer.

FIG. 3 depicts an example method for providing a content holding layer.

FIG. 4 depicts an example method for providing a content holding layer utilizing machine learning to generate recommended actions.

FIGS. 5A and 5B depict another method for providing a content holding layer in which content items are displayed in the content holding application surface and in which content items can be pinned to the content holding application.

FIG. 6 depicts another method for providing a content holding layer in which subsequent actions may be recommended upon execution of an action.

FIG. 7 depicts another method for providing a content holding layer in which actions are recommended for multiple content items that are selected in the content holding surface.

FIG. 8 is a block diagram illustrating example physical components of a computing device with which aspects of the technology may be practiced.

### DETAILED DESCRIPTION

The following detailed description refers to the accompanying drawings. Wherever possible, the same reference numbers are used in the drawing and the following description to refer to the same or similar elements. While aspects of the technology may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the technology, but instead, the proper scope of the technology is defined by the appended claims. Examples may take the form of a hardware implementation, or an entirely software implementation, or an implementation combining software and hardware aspects. The following detailed description is, therefore, not to be taken in a limiting sense.

The present technology relates to systems and methods that implement a content holding layer. While utilizing a computing device such as a personal computer or tablet, users may want to take certain actions on various content items stored on the computing device, such as send files to other users or locations, convert files to other formats, and/or upload content, among others. The present technology provides computing devices with the functionality to temporarily hold selected content items in a content holding layer and provide recommended actions that can be applied to content items in the content holding layer. The recommended actions may be selected with a goal of predicting a likely next action(s) to be requested (e.g., anticipating the users'intent) and thus provide a fast and convenient way to execute those actions. For example, conventionally, conversion of a text-based document into a Portable Document Format (PDF) document may include opening the text-based document, receiving navigation to a menu item within the document application, and receiving a selection of an option to convert the document into a PDF. With the technology of the present disclosure, the text-based document may be received into a content holding surface via a user input. The content holding surface provides one or more recommended actions, including an option to convert the text-based document into a PDF. Upon receiving a selection of the option to convert the document into a PDF, the computing device executes the action of converting the document into a PDF. Furthermore, multiple content items may be placed in the content holding surface and the recommended actions may be those that are applicable to the multiple content items in the content holding surface. Selected actions may be performed on the multiple content items at once. The techniques of the present disclosure allow the computing system to accomplish tasks with fewer processing steps and thus function more efficiently.

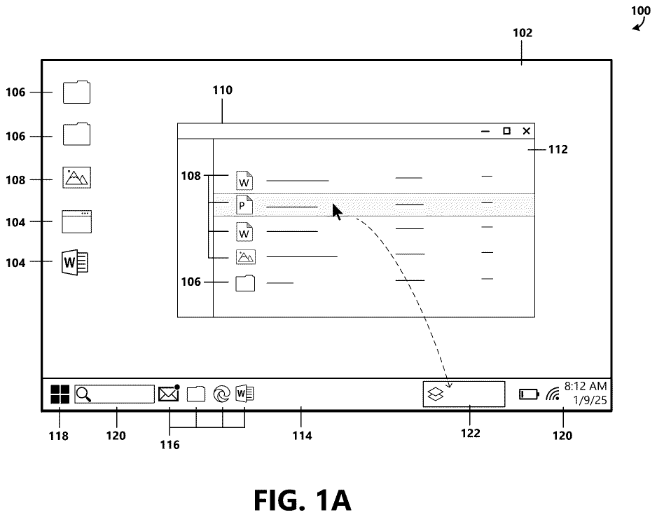

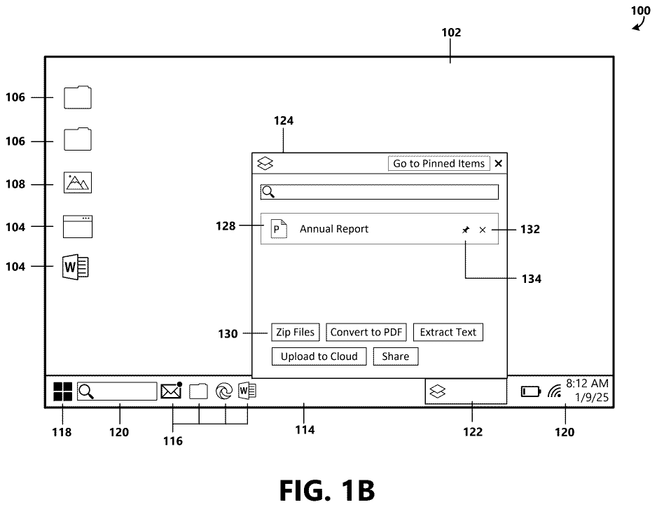

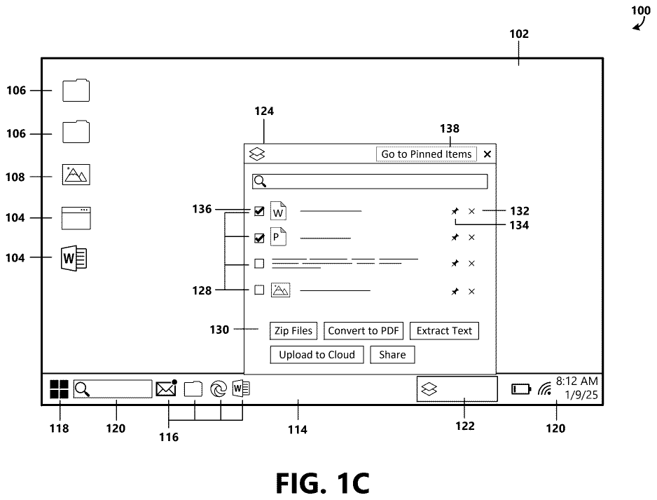

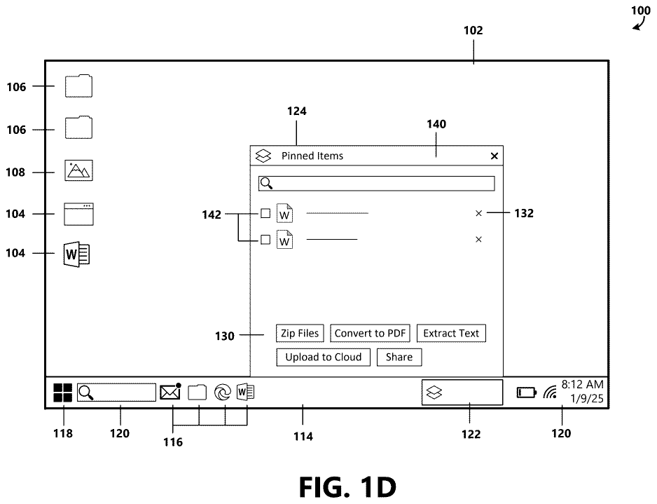

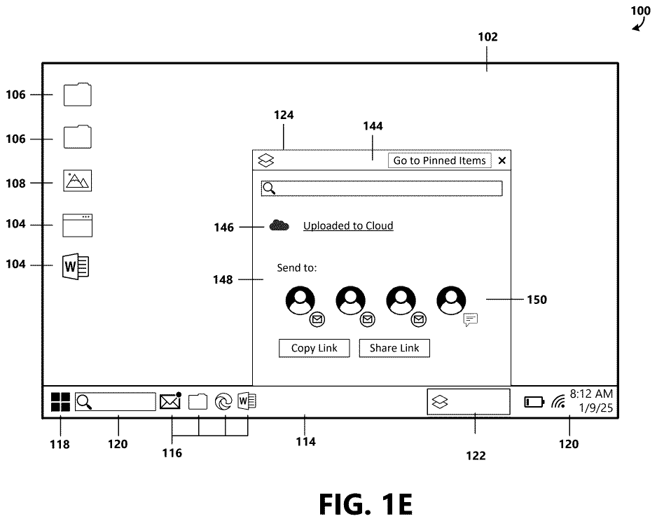

FIG. 1A depicts an example operating system desktop 100 of a computing device, such as a personal computer or tablet. The desktop 100 provides a graphical user interface (GUI) for interacting with applications 104, folders 106, files 108, and various other types of content. The desktop 100 further provides access to features and functionalities of the computing device and its operating system. For instance, the desktop 100 includes a workspace 102 that serves as a primary area or surface for a user to interact with applications 108, manage files 108 and folders 106, access functionalities of the computing system, and the like.

The workspace 102 is an area of the desktop 100 where application windows 110 may be displayed. The example application window 110 illustrated in FIG. 1A is a file management application 112, which may be a native feature of the operating system. In some embodiments, the file management application 112 provides a means of organizing files 108 and folders 106 stored on the computing device in an organizational structure, such as in a hierarchical or nested structure. The files 108 and folders 106, whether displayed directly on the desktop 100 or in the file management application 112, may be moved around the organizational structure such as by dragging or copying and pasting actions.

The desktop 100 further includes a taskbar 114 that displays currently running and/or pinned application indicators 116 and a start button 118 that provides access to various system features, settings, shortcuts to frequently used applications, etc. The depicted taskbar 114 includes additional features 120, such as a system clock, volume control, network connectivity, battery status, and a search button or bar. In some examples, system notifications (e.g., incoming messages or updates) are displayed in or expanded from the taskbar 106. In some embodiments, the taskbar 106 is not considered to be a part of the workspace 102 (e.g., application windows may not overlap or occlude the taskbar 106).

The operating system of the present disclosure includes a content holding layer implemented as a content holding application. In some embodiments, the content holding application is accessible via a content holding surface. In some embodiments, the content holding surface includes a content holding element 122 provided on the desktop 100. The content holding element 122 provides an interfacing element (e.g., UI element) that facilitates the adding of content items to the content holding layer. Specifically, content items such as files 108 and folders 106 can be placed in the content holding layer by dragging the content item into the content holding element 122, such as illustrated in FIG. 1A. Content items may also be added to the content holding layer by other means, such as via a copy action, a paste action, a click, a touch, a hotkey, a voice command, or a gesture, among others. The means by which a content item can be added to the content holding layer may depend on the type of computing device and its user input mechanisms, as well as accessibility settings. Although the content holding element 122 is positioned in the taskbar 106 in the illustrated example, in other instances, the content holding element 122 may be positioned anywhere on the desktop and take on various configurations. The content holding element 122 may be displayed on the desktop by default or hidden from view.

FIG. 1B depicts a visual implementation of content holding surface 124 displayed on the desktop 100. In some embodiments, the content holding surface 124 is an expanded view of the content holding element 122. The content holding surface 124 may be triggered for display upon detecting a user interaction (such as a click, gesture, touch, voice command, etc.) with the content holding element 122, or upon detecting a new item added to the content holding layer, among triggers. The content holding surface 124 may be minimized to the content holding element 122 or removed from view upon detecting an associated user interaction such as a selection of a minimization or closing element, clicking outside of the content holding surface 124, a second click of the content holding element 122, among others.

The content holding surface 124 displays the content items 128 that have been added to the content holding layer. Content items of various types may be added to the content holding layer, such as a file, a folder, an image, a hyperlink, and/or text. The content item may be a text file, an audio file, a video file, an html file, a PDF file, an executable file, various types of application specific files, or various types of file formats. The content item may be formatted or unformatted text, such as that selected from a document or from content displayed in a web browser, among many others. Similarly, the content item may be an image file that is saved on the computing device or selected (e.g., copied, dragged) from a document or web page. Detection of the selection may include detecting the dragging of a file, highlighted text, etc. into the content holding element 122 or content holding surface 124. In some embodiments, when a content item 128 is said to be “added” to the content holding layer, a representation of the content item 128 is added as an entry to a database associated with content holding application. Similarly, the content item may also be said to be added to the content holding application, content holding element 122 or content holding surface 124 with the same effect.

In the instance depicted in FIG. 1B, the content holding surface 124 has one content item 128. The representation of the content item 128 may include a file name, a portion of the content item, content type, other metadata, data derived from the content item, a summary of the content item, and/or a pointer to the content item. In some instances, the representation of the content item 128 includes a copy of the content item or a link thereto. In some embodiments, the representation of the content item 128 is based on the type of content item, file size, or various other factors. For example, if the content item 128 is a file such as a document, the representation that is added to the content holding application may be metadata of the file, including file name, file type, file location, file owner, among other types of metadata. If the content item 128 is copied text or a link, which are lightweight (e.g., small) in size, the representation of the content item 128 may be the entirety of the content item 128.

The content holding surface 124 also includes one or more dynamically presented action indicators 130 that are applicable to the content items 128 displayed in the content holding surface 124. The action indicators 130 are presented as selectable elements (e.g., buttons) that allow the content holding application to receive a user input indicative of a selection of an action to be executed. Different dynamically presented action indicators 130 may be presented for different content items 128. When a selection of an action indicator 130 is received, the corresponding action is executed on or in association with the content item 128. Execution of the action may involve one or more other applications or functionalities of the operating system. For example, the dynamically presented action indicators 130 may correspond to actions for sharing the content item, converting the content item to another format, compressing the content item, uploading the content item, opening the content item, extracting text from the content item, or creating a link to the content item, among other potential actions. The action indicators 130 may be presented as selectable elements such as buttons or links. In some embodiments, the action indicators 130 may be presented aurally. The means of providing the selectable action indicators 130 and receiving a user selection of the action indicators 130 may depend on the computing device type and accessibility settings.

In some embodiments, the action indicators 130 represent recommended actions that determined are based at least in part on the content type of the content item 128. In some embodiments, determining the recommended actions includes obtaining a list of available actions for the content type. The list of available actions may include all actions that the operating system is able to execute for the content type. In some embodiments, the recommended actions include actions from the list of available actions. In some embodiments, the recommended actions are a subset of the list of available actions, determined based on predicted relevance or likelihood of being executed with respect to the content item 128. The recommended actions may be selected from the list of available actions based at least in part on contextual information associated with the computing environment. The contextual information may include currently or recently opened applications, currently or recently opened files, recently executed actions, user behavior history, user profile data, frequently used contacts, content of messages, content of the content item, metadata of the content item, among others. Such contextual information may be used to predict and thus anticipate a user's intent.

FIG. 1C depicts an instance of the content holding application surface 124 in which multiple content items 128 have been added to the content holding application. In some embodiments, the action indicators 130 presented represent actions that are applicable to all of the content items 128 currently in the content holding application. In some embodiments, a subset of the content items 128 in the content holding application can be selected such that the action indicators 130 presented represent actions that are applicable to the selected content items. In the example depicted in FIG. 1C, check boxes 136 are provided as an input element for selecting the content items 128. In this example, the first two content items 128 are selected. Thus, the actions 130 presented are those that are applicable to both of the first two content items 128 (i.e., the selected content items). As additional content items 128 are selected or deselected, the actions 130 presented may be dynamically updated to reflect the currently selected content items 128.

In some embodiments, the content holding surface 124 includes other interfacing elements such as a remove item element 132 and a pin item element 134 for each content item 128. The remove item element 132 removes the respective content element 128 from the content holding application. The pin item element 134 pins the respective content element 128 to the content holding application, which gives the content element 128 a persistent state, e.g., until the content element 128 is unpinned. A pinned items element 138, when selected, displayed a pinned items view 140 of the content holding surface 124, which is depicted in FIG. 1D. The pinned items view 140 includes pinned content items 142, which are the content items that have been pinned to the content holding application. In some embodiments, an unpinned content item 128 is automatically removed from the content holding application once an action has been executed on the content item 128. A pinned content item 142 remains in the content holding application after an action is executed. Pinned content items 142 may be removed from the content holding application by selecting the remove item element 132.

In some embodiments, when an action is executed for one or more content items 128, a result of executing the action is displayed in a confirmation view 144 of the content holding surface 124, depicted in FIG. 1E. The confirmation view 144 indicates a confirmation or result 146 of executing the action. In the illustrated embodiment, the confirmation or result 146 is that a file has been uploaded to a cloud drive and includes a link to the file location in the cloud drive. In another example, if the executed action was to compress (e.g., zip) a folder, the confirmation or result 146 may include the compressed (e.g., zipped) file or a link thereto. The confirmation surface 144 may also include one or more subsequent action indicators 148. Similar to action indicators 130, the subsequent action indicators 148 are selectable elements that represent subsequent actions that are applicable to the either the original content item 128 or the result 146 of executing the previous action on the content item 128. In the illustrated example, the subsequent action indicators 148 include options to send the file location to one or more suggested contacts 150. The suggested contacts 150 may include contacts associated with one or more applications, such as an email application or an instant message/chat application. The suggested contacts 150 may be determined based on various factors such as frequently used contacts or contacts that are known to be associated with the content item, such as users who have previously accessed the content item or users who have requested or mentioned the content item in communications.

In another example, if the first action was to convert a text-based document to a PDF file, the subsequent actions may include recommended actions that are applicable to the PDF file. In some examples, the subsequent actions include some actions that are applicable to the original content item and some actions that are applicable to the result of the first action. For instance, in the example of uploading the content item to a cloud drive, the subsequent actions may include an action for sharing the original content item and an action for sharing a link to the content item in the cloud drive. The subsequent actions may be determined using techniques similar to that of determining the initial set of recommended actions, such as from a list of all available actions or selecting a subset of the available actions based on contextual information.

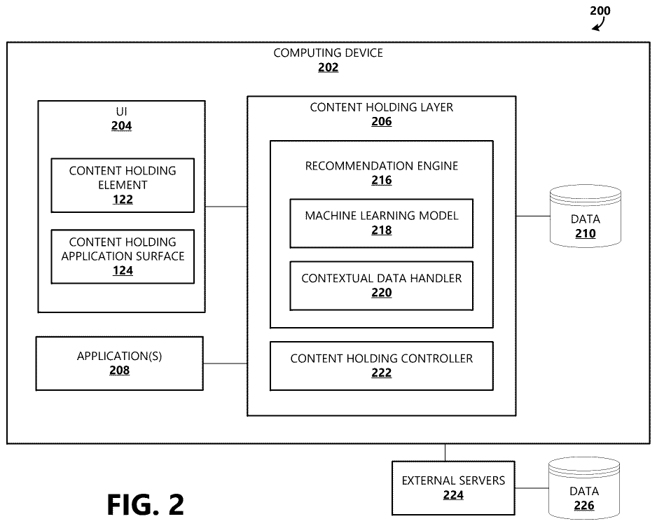

FIG. 2 depicts an example system 200 for implementing the content holding layer. The system 200 includes a computing device 202 that generates and/or includes a user interface 204 such as desktop 100, a content holding layer 206, one or more applications 208, and stored data 210. The user interface 204 includes the content holding element 122 and the content holding surface 124. In some embodiments, the content holding layer 206 is visually represented by the content holding element 122 and the content holding surface 124. Content items 128 such as files 108 and folders 106 can be placed in the content holding layer 206 by dragging the content item 128 into the content holding element 122, such as illustrated in FIG. 1A. Content items 128 may also be added to the content holding layer 206 by other means, such as via a copy action, a click, a touch, a hotkey, a voice command, a gesture, dragging or pasting the content items 128 into the content holding surface 124, among others. The means by which a content item 128 can be added to the content holding application may depend on the type of computing device 202 and its user input mechanisms, as well as accessibility settings. The content holding surface 124 is an expansion of the content holding element and may display the content items that have been added to the content holding layer 206. The desktop 100 depicted in FIGS. 1A, 1B, 1C, 1D, and 1E is an example user interface 204 or interfacing mechanism by which a user can interact with the content holding layer 206. Other types of computing devices or other settings may utilize different interfacing mechanisms by which a user can interact with the content holding layer 206. The content holding surface 124 may provide action indicators 130 that correspond to one or more recommended actions that can be executed on or in association with one or more of the content items 128 displayed in the content holding surface 124.

The content holding layer 206 may further include a recommendation engine 216. The recommendation engine determines the one or more recommended actions that can be executed on one or more content items 128 in the content holding layer 206. In some embodiments, the recommended actions are determined based at least in part on the content type of the content item. In some embodiments, the recommendation engine 216 obtains a list of available actions for the content type. The list of available actions may include all actions that the operating system of the computing device 202 is able to execute for that content item 128.

In the example depicted, the recommendation engine 216 further includes one or more machine learning models 218 and/or one or more contextual data handlers 220. The recommendation engine 216 may utilize the contextual data handler 220 to obtain contextual information about the computing environment of the computing device 202. The contextual information may include currently or recently opened applications 208, currently or recently opened files, recently executed actions, user behavior history, user profile data, frequently used contacts, content of messages, content of the content item, metadata of the content item, among others. Such contextual information may provide insight that can be used to predict the next actions likely to be performed and thus anticipate the user's intent.

An example instance of the contextual data handler 220 extracts such contextual information from the computing environment. The contextual data handler 220 may extract different types of data from different types of applications 208 and different types of content items 128. For example, the contextual data handler 220 may utilize algorithms and machine learning (ML) models to determine what type of content is present in the applications 208 and determine what type of data to extract or interpret. For example, the contextual data handler 220 may extract a first type of context from a first type of application (e.g., email client), and a further example contextual data handler 220 extracts a second type of context from a second type of application (e.g., PDF viewer). In some examples, text corresponding to entities can be extracted from applications 208 and categorized and/or classified according to an ML model and/or through named entity recognition (NER) algorithms. In some examples, the ML models include Open Neural Network Exchange (ONNX) ML models or the like. For instance, entities are extracted from the text, images, code, and other content of the applications 208. The extracted entities and/or their classifications/categorizations are a type of context. Other types of context can be extracted from the applications 208. In some embodiments, various functions of the contextual data handler 220 may be performed by a server 224 external to and/or remote from the computer device 202.

The contextual information obtained or generated by the contextual data handler 220 may be processed using the machine learning model 218, which is trained to recommend actions based on the contextual information. The machine learning model 218 may be trained on global data from a broad range of computing environments or users and/or local data that is specific to the present computing environment or user account. Training data for the machine learning model may include various contextual information of a computing environment and the actions executed on content items in a content holding application or independently of the content holding application. This training data may provide patterns that connect various contextual information of the computing environment to certain actions. Thus, the trained machine learning model may be able to predict the likelihood that certain actions will be executed based on present contextual information of a computing environment. The machine learning model 218 may continuously learn a particular user's usage patterns based on which of the recommended actions the user does select, if any. In some embodiments, the recommendation engine 216 may select the one or more recommended actions for presentation to the user from the list of available actions based at least in part on the output of the machine learning model 218. The machine learning model 218 may be executed on the computing device 202 or on an external/remote server 224 data 210 stored on the computing device or on an external/remote database 226.

The content holding layer 206 may further include a content holding controller 222. When one of the recommended actions is selected, the content holding controller 222 may execute or initiate the execution of the selected action. The content holding controller 222 may control various applications 208 or other functionality or services of the computing device to complete the selected action.

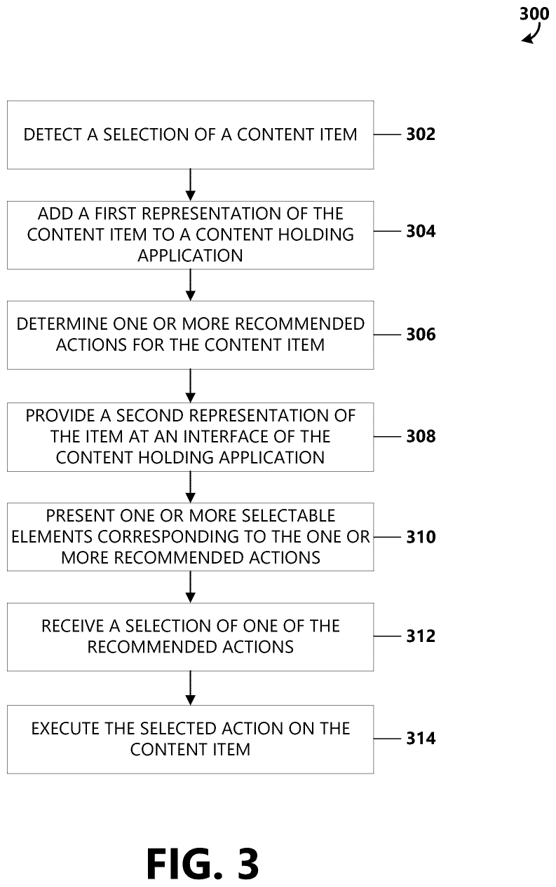

FIG. 3 depicts an example method 300 of providing a content holding layer. The operations of method 300 are performed by a computing device, such as a computing device providing the content holding layer or an external/remote server providing the content holding layer. At operation 302, a selection of a content item in a computing environment is detected. The content item may be of a certain content type, such as file, a folder, an image, a hyperlink, or text. The content item may be a text file, an audio file, a video file, an html file, a PDF file, an executable file, various types of application-specific files, or various types of file formats. The content item may be formatted or unformatted text, such as that selected from a document or from content displayed in a web browser, among many others. Similarly, the content item may be an image file that is saved on the computing device or selected (e.g., copied, dragged) from a document or web page. Detection of the selection may include detecting the dragging of a file, highlighted text, etc. into a content holding element. In various embodiments, the detection may be made at the initiation of the drag or at the completion (i.e., release) of the drag in the content holding element. Detection of the selection of the content item may also be triggered by a copy action, a voice command, a click action such as a right click and a selection made from a menu of options to add the content item to the content holding layer, among others. Various other types of inputs may be utilized depending on the computing device type, input modalities available, and accessibility settings.

At operation 304, a first representation of the content item is added to the content holding application upon detecting the selection at operation 302. In some embodiments, the first representation is added to a database associated with the content holding application and includes metadata of the content item, data derived from the content item, a summary of the content item, a copy of the content item, or a pointer to the content item. At operation 306, one or more recommended actions for the content item is determined. The recommended actions may include actions that are executable by the operating system of the computing device with respect to the content item. In some embodiments, the recommended actions are determined based at least in part on the content type of the content item. In some embodiments, determining the recommended actions includes obtaining a list of available actions for the content type. The list of available actions may include all actions that the operating system is able to execute for the content type. In some embodiments, the one or more recommended action includes actions in the list of available actions.

In some embodiments, the one or more recommended actions is a subset of the list of available actions, determined based on predicted relevance or likelihood of being executed with respect to the content item. The recommended actions may be selected from the list of available actions based at least in part on contextual information associated with the computing environment. The contextual information may include currently or recently opened applications, currently or recently opened files, recently executed actions, user behavior history, user profile data, frequently used contacts, content of messages, content of the content item, metadata of the content item, among others.

At operation 308, the content item that was added to the content holding application in operation 304 may be provided at an interface of the content holding application, such as the content holding surface. Specifically, a second representation of the content item may be displayed in the content holding surface. The second representation of the content item may include a file name, label, a portion of the content, and/or other information related to the content item such as content/file type, size, and in some instances an icon indicating the file type. The information included in the second representation of the content item may vary depending on the content type. For example, if the content item is a document file, the second representation shown in the content holding surface may include the file name and file type. If the content item is copied text, the second representation may be a portion or the entirety of text, depending on the length of the text and/or space available.

At operation 310, one or more selectable elements corresponding to the one or more recommended actions may be presented in the content holding surface. The selectable elements may be UI elements such as buttons. At operation 312, a selection of one of the recommended actions is received, such as by detecting a selection of the corresponding UI element. At operation 314, the selected action is executed on or in association with the content item. The executed action may be sharing the content item, converting the content item to another format, compressing (e.g., zipping) the content item, uploading the content item, opening the content item, extracting text from the content item, creating a link to the content item, among many others.

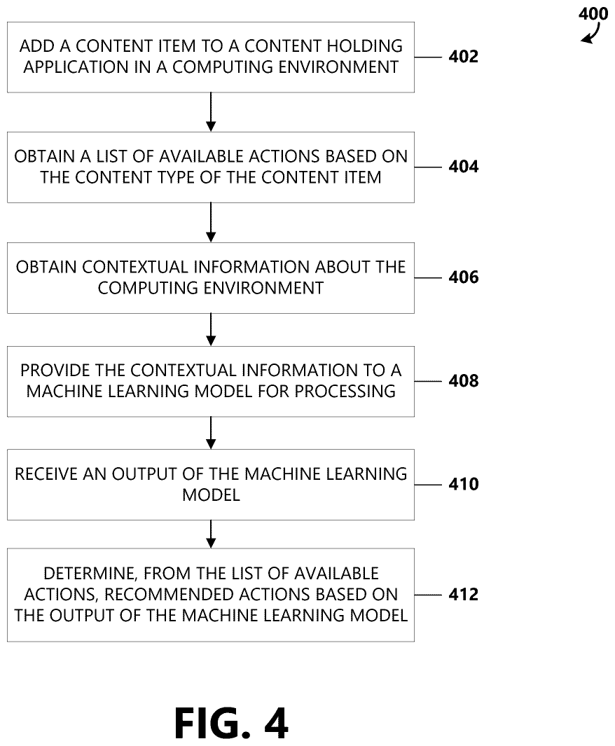

FIG. 4 depicts a method 400 of providing a content holding layer utilizing machine learning to generate recommended actions. At operation 402, a content item is added to a content holding application. In some embodiments, data representing the content item is added by the computing device to a database associated with the content holding application. Operation 402 may be triggered upon detecting a corresponding user input. At operation 404, a list of available actions is obtained. In some embodiments, the list of available actions depends on the content type of the content item, since some actions are applicable only to certain content types and not others. At operation 406, contextual information about the computing environment is obtained. The contextual information may include currently or recently opened applications, currently or recently opened files, recently executed actions, user behavior history, user profile data, frequently used contacts, content of messages, content of the content item, metadata of the content item, among others.

At operation 408, the contextual information is provided as input to a machine learning model trained to recommend actions based on contextual information. The machine learning model may be trained on global data from a broad range of computing environments or users and/or local data that is specific to the present computing environment or user account. Training data for the machine learning model may include various contextual information of a computing environment and the actions executed on content items in a content holding application or independently of the content holding application. This training data may provide patterns that connect various contextual information of the computing environment to certain actions. Thus, the trained machine learning model may be able to predict the likelihood that certain actions will be executed based on present contextual information of a computing environment. At operation 410, an output of the machine learning model is received. At operation 412, one or more recommended actions is determined from the list of available actions based at least in part on the output of the machine learning model. In some embodiments, the machine learning model may be executed on the computing device or on an external/remote server using data stored on the computing device or on an external/remote database.

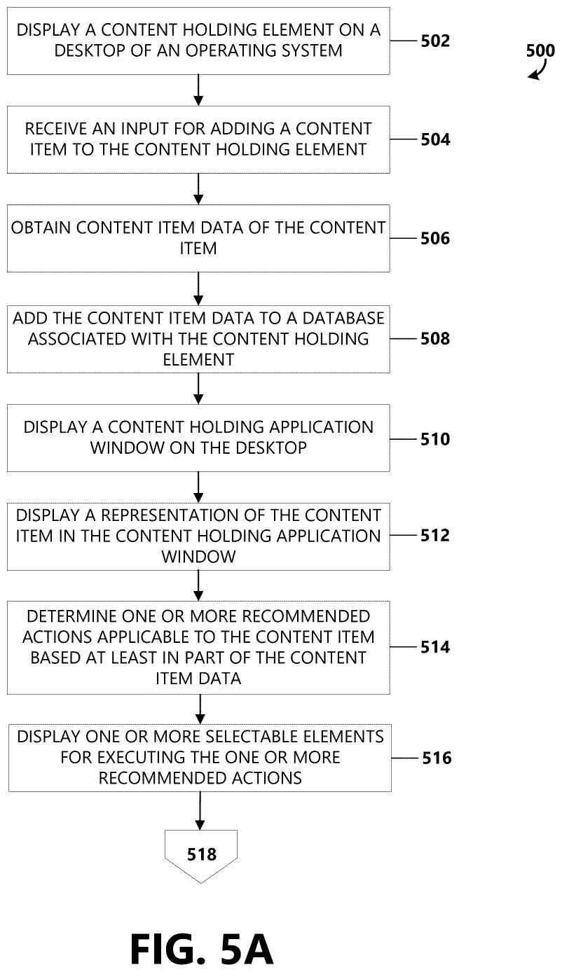

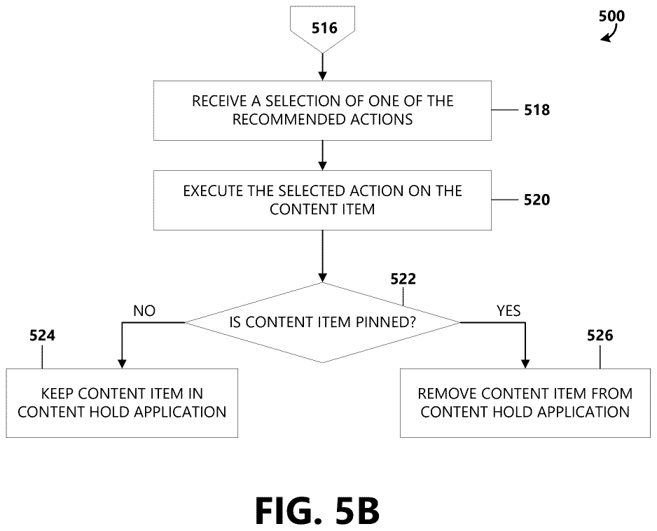

FIGS. 5A and 5B depict another method 500 for providing a content holding layer in which content items are displayed in a content holding surface and in which content items can be pinned to the content holding layer. Referring to FIG. 5A, at operation 502, a content holding element is displayed on a desktop of an operating system. At operation 504, an input for adding the content item to the content holding element is received. In some embodiments, this may include a dragging action, in which the content item is dragged, such as from the desktop or the file management application to the content holding element. The input may also be a hotkey, a click (or touch in the case of a touch-based device), a gesture, a voice command, right click menu selection, a copy action, among others. At operation 506, content item data of the content item is obtained. The content item data may include metadata of the content item, extracted information, entity data, a summary, content item type, or at least a portion of content item contents. At operation 508, the content item data may be added to a database associated with the content holding element.

At operation 510, a content holding surface, such as a content holding application window, is displayed on the desktop. At operation 512, a representation of the content item is displayed in the content holding surface. The representation of the content item may include the file or folder name if the content item is file or folder, or a preview of the content item if the content item is a copied image or text. At operation 514, one or more recommended actions applicable to the content item are determined based at least in part of the content item data. At operation 516, one or selectable elements for executing the one or more recommended actions are displayed. Referring now to FIG. 5B, at operation 518, a selection of one of the recommended actions is received. At operation 520, the selected action is executed on or in association with the content item. In some embodiments, at operation 522, a determination is made with respect to whether the content item is pinned to the content holding application. If the content item has been pinned to the content holding application, then operation 524 occurs and the content item remains in the content holding application. If the content application has not been pinned to the content holding application, then operation 526 occurs and the content item is removed from the content holding application upon execution of the action.

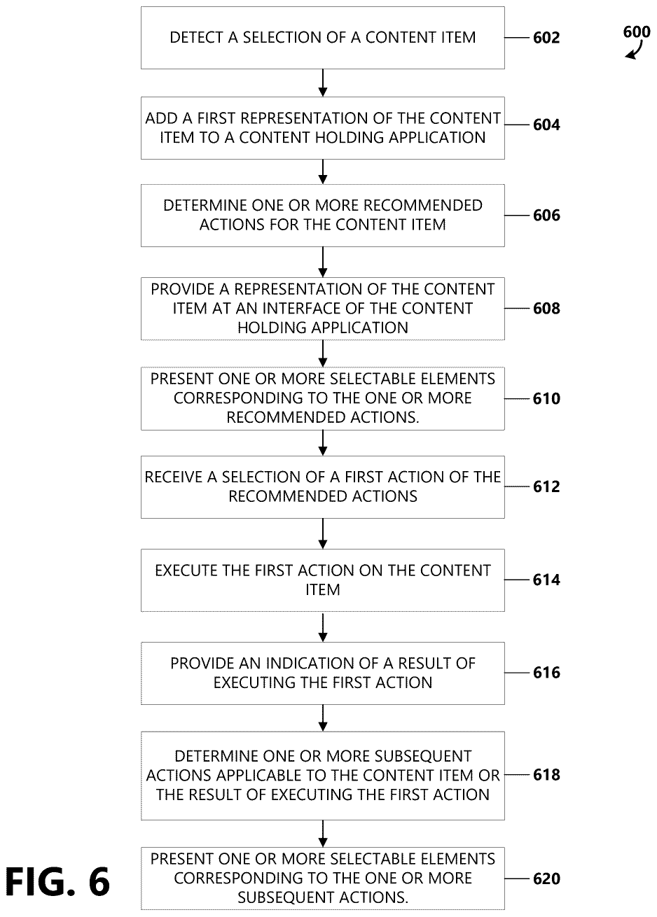

FIG. 6 depicts another method 600 for providing a content holding layer in which subsequent actions may be recommended upon execution of an action. At operation 602, a selection of a content item is detected. The content item may be a file of various formats (e.g., images, video, pdf, documents, executables, application specific files), a folder, copied text, copied image, links, among others. Detection of the selection may include detecting a drag input of the content item being dragged into the content holding element. At operation 604, a first representation of the content item is added to a content holding application upon detecting the selection. In some embodiments, data representing the content item is added by the computing device to a database associated with the content holding application. At operation 606, one or more recommended actions for the content item are determined. The recommended actions may be determined in various ways. For example, the recommended actions may be a list of all available actions that are applicable to the content item, such as based on its content type. The recommended actions may be a subset of the available actions, selected or ordered based on recently or frequently used actions. The recommended actions may also be selected by inputting contextual information (e.g., currently or recently open applications, currently or recently opened files, user behavior history, user profile data, frequently used contacts, content of messages, content of the content item, metadata of the content item) into a machine learning model trained to predict the most likely actions based on the contextual information.

At operation 608, a representation of the content item is provided (e.g., displayed) at an interface of the content holding application. At operation 610, one or more selectable elements corresponding to the one or more recommended actions are presented. At operation 612, a selection of a first action of the recommended actions is received. At operation 614, the first action is executed on the content item. For example, the first action may be to upload the content item to a cloud drive. At operation 616, an indication of a result of executing the first action is provided. For example, this may include displaying a confirmation that the action has been completed and/or an item that was generated in the execution of the first action, such as a link, converted file, etc.

At operation 618, one or more subsequent actions that are applicable to either the content item or the result of executing the action on the content item is determined. In some embodiments, the subsequent actions are actions that are applicable to the result of executing the first action. For instance, in the example of uploading the content item to a cloud drive, the subsequent actions may include sharing a link to the content item in the cloud drive (i.e., the result of the uploading the content item to the cloud drive). In another example, if the first action was to convert a text-based document to a PDF file, the subsequent actions may include recommended actions that are applicable to the PDF file. In some examples, the subsequent actions include some actions that are applicable to the original content item and some actions that are applicable to the result of the first action. For instance, in the example of uploading the content item to a cloud drive, the subsequent actions may include an action for sharing the original content item and an action for sharing a link to the content item in the cloud drive. The subsequent actions may be determined using techniques similar to that of determining the initial set of recommended actions, such as from a list of all available actions or selecting a subset of the available actions based on contextual information. At operation 620, one or more selectable elements corresponding to the one or more subsequent actions are presented for selection in the content holding application surface.

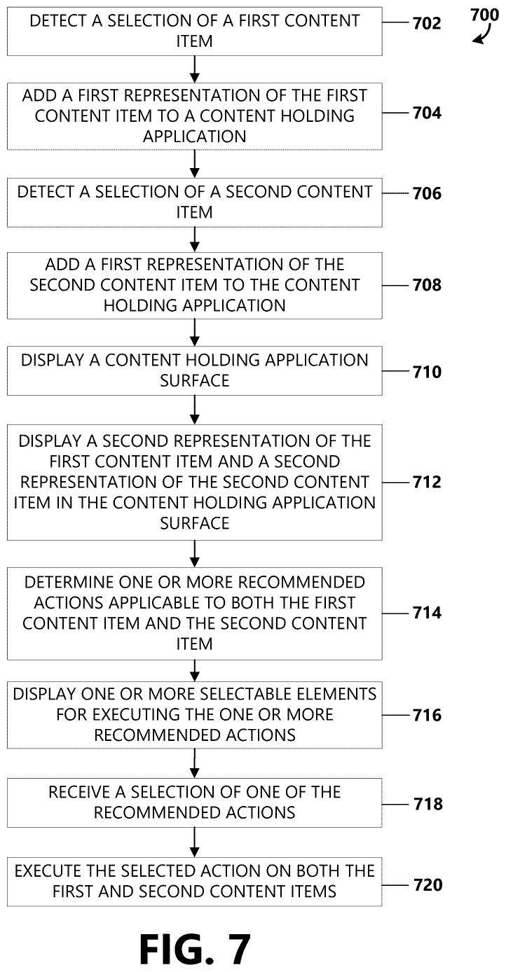

FIG. 7 depicts another method 700 for providing a content holding layer in which actions are recommended for multiple content items that are selected in the content holding surface. At operation 702, a selection of a first content item is detected. At operation 704, a first representation of the first content item is added to a content holding application. In some embodiments, data representing the first content item is added by the computing device to a database associated with the content holding application. At operation 706, a selection of a second content item is detected. At operation 708, a first representation of the second content item is added to the content holding application. In some embodiments, data representing the second content item is added by the computing device to the database associated with the content holding application. At operation 710, a content holding surface is displayed on the desktop of the operation system. At operation 712, a second representation (e.g., title, file type, preview) of the first content item and a second representation of the second content item are displayed in the content holding surface. At operation 714, one or more recommended actions applicable to both the first and second content items are determined. In other words, in some embodiments, only actions that can be applied to both and the first and second content items are included, and actions that are only appliable to one of the content items but not the other are not included. The first and second content items may be of the same content type or different content types. At operation 716, one or more selectable elements corresponding to the one or more selectable elements are displayed on the content holding surface. At operation 718, a selection of one of the recommended actions is received. At operation 720, the selected action is executed on or in association with both the first and second content items.

There may also be additional content items in the content holding application in addition to the first and second content items. The first and second items may be selected within the content holding surface, such as via a checkbox, for the recommended actions to be those that applicable to the first and second items. More generally, in some embodiments, the recommended actions are those that are applicable to all of the selected content items within the content holding surface when there are multiple content items in the content holding application. In some embodiments, if none of the content items are selected, then the recommended actions are those that are applicable to all of the content items in the content holding application.

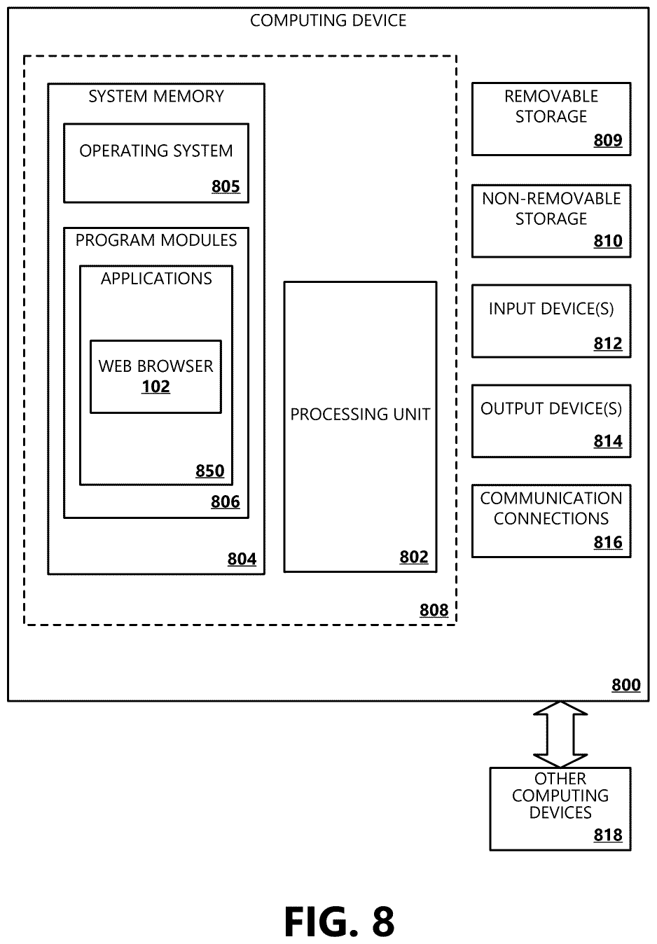

FIG. 8 and the associated description provide a discussion of a variety of operating environments in which examples of the invention may be practiced. However, the devices and systems illustrated and discussed with respect to FIG. 8 is for purposes of example and illustration and is not limiting of a vast number of computing device configurations that may be utilized for practicing aspects of the invention, described herein. FIG. 8 is a block diagram illustrating physical components (i.e., hardware) of a computing device 800 with which examples of the present disclosure may be practiced. The computing device components described below may be suitable for a client device running the web browser discussed above. In a basic configuration, the computing device 800 may include at least one processing unit 802 and a system memory 804. The processing unit(s) (e.g., processors) may be referred to as a processing system. Depending on the configuration and type of computing device, the system memory 804 may comprise, but is not limited to, volatile storage (e.g., random access memory), non-volatile storage (e.g., read-only memory), flash memory, or any combination of such memories. The system memory 804 may include an operating system 805 and one or more program modules 806 suitable for running software applications 850 such as a content holding layer 206 and one or more browser and/or non-browser desktop applications.

The operating system 805, for example, may be suitable for controlling the operation of the computing device 800. Furthermore, aspects of the invention may be practiced in conjunction with a graphics library, other operating systems, or any other application program and is not limited to any particular application or system. This basic configuration is illustrated in FIG. 8 by those components within a dashed line 808. The computing device 800 may have additional features or functionality. For example, the computing device 800 may also include additional data storage devices (removable and/or non-removable) such as, for example, magnetic disks, optical disks, or tape. Such additional storage is illustrated in FIG. 8 by a removable storage device 809 and a non-removable storage device 810.

As stated above, a number of program modules and data files may be stored in the system memory 804. While executing on the processing unit 802, the program modules 806 may perform processes including, but not limited to, one or more of the operations of the methods illustrated in FIGS. 3-7. Other program modules that may be used in accordance with examples of the present invention and may include applications such as electronic mail and contacts applications, word processing applications, spreadsheet applications, database applications, slide presentation applications, drawing or computer-aided application programs, etc.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 8 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to generating suggested queries, may be operated via application-specific logic integrated with other components of the computing device 800 on the single integrated circuit (chip). Examples of the present disclosure may also be practiced using other technologies capable of performing logical operations such as, for example, AND, OR, and NOT, including but not limited to mechanical, optical, fluidic, and quantum technologies.

The computing device 800 may also have one or more input device(s) 812 such as a keyboard, a mouse, a pen, a sound input device, a touch input device, etc. The output device(s) 814 such as a display, speakers, a printer, etc. may also be included. The aforementioned devices are examples and others may be used. The computing device 800 may include one or more communication connections 816 allowing communications with other computing devices 818. Examples of suitable communication connections 816 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 804, the removable storage device 809, and the non-removable storage device 810 are all computer storage media examples (i.e., memory storage.) Computer storage media may include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 800. Any such computer storage media may be part of the computing device 800. Computer storage media does not include a carrier wave or other propagated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

One or more embodiments of the present disclosure provide a system for providing a content holding layer, the system comprising: a processing system; and memory storing instructions that, when executed by the processing system, cause the system to: detect a selection of a content item in a computing environment, the content item being of a content type; add a first representation of the content item to a content holding application provided by the computing environment; present the content holding application via an interface of the computing environment, the content holding application including a second representation of the content item; determine one or more recommended actions applicable to the content item based at least in part on the content type, the one or more recommended actions being executable by the computing environment; and present one or more selectable elements corresponding to the one or more recommended actions via the interface.

In some embodiments, the instructions further cause the system to: receive a selection of a first action of the recommended actions; and execute the first action on the content item.

In some embodiments, the instructions further cause the system to: determine one or more subsequent actions applicable to the content item or a result of executing the first action on the content item.

In some embodiments, determining the one or more recommended actions further causes the system to: obtain a list of available actions for the content type.

In some embodiments, determining the one or more recommended actions further causes the system to: select the one or more recommended actions from the list of available actions based at least in part on contextual information associated with the computing environment.

In some embodiments, the contextual information includes one or more of: currently or recently open applications, currently or recently opened files, user behavior history, user profile data, frequently used contacts, content of messages, content of the content item, or metadata of the content item.

In some embodiments, determining the one or more recommended actions further causes the system to: input the contextual information into a machine learning model trained to recommend actions based on contextual information; and obtain an output from the machine learning model.

In some embodiments, the content type is a file, a folder, an image, a hyperlink, or text.

In some embodiments, the first representation includes metadata of the content item, data derived from the content item, a summary of the content item, a copy of the content item, or a pointer to the content item; and the second representation includes a file name, a label, file type indicator, or a portion of the content item.

In some embodiments, the one or more recommended actions include one or more of: sharing the content item, converting the content item to another format, zipping the content item, uploading the content item, opening the content item, extracting text from the content item, or creating a link to the content item.

One or more embodiments of the present disclosure provides a computer-implemented method for providing a content holding layer, the method comprising: displaying a content holding element on a desktop of an operating system; receiving an input for adding a content item to the content holding element; obtaining content item data of the content item; adding the content item data to a database associated with the content holding element; displaying a content holding application on the desktop; displaying a representation of the content item in the content holding application; determining one or more recommended actions applicable to the content item based at least in part of the content item data; and displaying, in the content holding application, one or more selectable elements for executing the one or more recommended actions.

In some embodiments, the content item data includes at least one of: content item type, metadata, extracted information, an artificial intelligence (AI) generated profile, entity data, a summary, or at least a portion of content item contents.

In some embodiments, the method further comprises: detecting a selection of a first action of the one or more recommended actions; executing the first action on the content item; and removing the content item from the content holding application upon execution of the first action.

In some embodiments, the method further comprises: receiving a first input to add the content item to a persistent portion of the content holding application; and keeping the content item in the content holding application until a second input is received to remove the content item from the content holding application.

In some embodiments, the input includes a drag action, a copy action, a click, a touch, a hotkey, a voice command, or a gesture.

One or more embodiments of the present disclosure provide a system for providing a content holding layer, the system comprising: a processing system; and memory storing instructions that, when executed by the processing system, cause the system to: detect a selection of a first content item in a computing environment; add a first representation of the first content item to a content holding application provided by the computing environment; detect a selection of a second content item in the computing environment; add a first representation of the second content item to the content holding application; display a content holding application window on a desktop of the computing environment, the content holding application window including a second representation of the first content item and a second representation of the second content item; determine one or more recommended actions applicable to both the first content item and the second content item; and display one or more selectable elements corresponding to the one or more recommended actions.

In some embodiments, the instructions further cause the system to: receive a selection of one of the one or more recommended actions; and execute the selected action on the first and second content items.

In some embodiments, the first content item and the second content item are of a same content type.

In some embodiments, the first content item and the second content item are of different content types.

In some embodiments, the content holding application window displays a third content item, and the first and second content items are selected within the content holding application window.

Aspects of the present invention, for example, are described above with reference to block diagrams and/or operational illustrations of methods, systems, and computer program products according to aspects of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved. Further, as used herein and in the claims, the phrase “at least one of element A, element B, or element C” is intended to convey any of: element A, element B, element C, elements A and B, elements A and C, elements B and C, and elements A, B, and C.

The description and illustration of one or more examples provided in this application are not intended to limit or restrict the scope of the invention as claimed in any way. The aspects, examples, and details provided in this application are considered sufficient to convey possession and enable others to make and use the best mode of claimed invention. The claimed invention should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope of the claimed invention.

We claim:

1. A system for providing a content holding layer, the system comprising:
a processing system; and
memory storing instructions that, when executed by the processing system, cause the system to:
detect a selection of a content item in a computing environment, the content item being of a content type;
add a first representation of the content item to a content holding application provided by the computing environment;
present the content holding application via an interface of the computing environment, the content holding application including a second representation of the content item;
determine one or more recommended actions applicable to the content item based at least in part on the content type, the one or more recommended actions being executable by the computing environment; and
present one or more selectable elements corresponding to the one or more recommended actions via the interface.

2. The system of claim 1, wherein the instructions further cause the system to:
receive a selection of a first action of the recommended actions; and
execute the first action on the content item.

3. The system of claim 2, wherein the instructions further cause the system to:
determine one or more subsequent actions applicable to the content item or a result of executing the first action on the content item.

4. The system of claim 1, wherein determining the one or more recommended actions further causes the system to:
obtain a list of available actions for the content type.

5. The system of claim 4, wherein determining the one or more recommended actions further causes the system to:
select the one or more recommended actions from the list of available actions based at least in part on contextual information associated with the computing environment.

6. The system of claim 5, wherein the contextual information includes one or more of: currently or recently open applications, currently or recently opened files, user behavior history, user profile data, frequently used contacts, content of messages, content of the content item, or metadata of the content item.

7. The system of claim 5, wherein determining the one or more recommended actions further causes the system to:
input the contextual information into a machine learning model trained to recommend actions based on contextual information; and
obtain an output from the machine learning model.

8. The system of claim 1, wherein the content type is a file, a folder, an image, a hyperlink, or text.

9. The system of claim 1, wherein:
the first representation includes metadata of the content item, data derived from the content item, a summary of the content item, a copy of the content item, or a pointer to the content item; and
the second representation includes a file name, a label, file type indicator, or a portion of the content item.

10. The system of claim 1, wherein the one or more recommended actions include one or more of: sharing the content item, converting the content item to another format, zipping the content item, uploading the content item, opening the content item, extracting text from the content item, or creating a link to the content item.

11. A computer-implemented method for providing a content holding layer, comprising:
displaying a content holding element on a desktop of an operating system;
receiving an input for adding a content item to the content holding element;
obtaining content item data of the content item;
adding the content item data to a database associated with the content holding element;
displaying a content holding application on the desktop;
displaying a representation of the content item in the content holding application;
determining one or more recommended actions applicable to the content item based at least in part of the content item data; and
displaying, in the content holding application, one or more selectable elements for executing the one or more recommended actions.

12. The computer-implemented method of claim 11, wherein the content item data includes at least one of: content item type, metadata, extracted information, an artificial intelligence (AI) generated profile, entity data, a summary, or at least a portion of content item contents.

13. The computer-implemented method of claim 11, further comprising:
detecting a selection of a first action of the one or more recommended actions;
executing the first action on the content item; and
removing the content item from the content holding application upon execution of the first action.

14. The computer-implemented method of claim 11, further comprising:
receiving a first input to add the content item to a persistent portion of the content holding application; and
keeping the content item in the content holding application until a second input is received to remove the content item from the content holding application.

15. The computer-implemented method of claim 11, wherein the input includes a drag action, a copy action, a click, a touch, a hotkey, a voice command, or a gesture.

16. A system for providing a content holding layer, the system comprising:
a processing system; and
memory storing instructions that, when executed by the processing system, cause the system to:
detect a selection of a first content item in a computing environment;
add a first representation of the first content item to a content holding application provided by the computing environment;
detect a selection of a second content item in the computing environment;
add a first representation of the second content item to the content holding application;
display a content holding application window on a desktop of the computing environment, the content holding application window including a second representation of the first content item and a second representation of the second content item;
determine one or more recommended actions applicable to both the first content item and the second content item; and
display one or more selectable elements corresponding to the one or more recommended actions.

17. The system of claim 16, wherein the instructions further cause the system to:
receive a selection of one of the one or more recommended actions; and
execute the selected action on the first and second content items.

18. The system of claim 16, wherein the first content item and the second content item are of a same content type.

19. The system of claim 16, wherein the first content item and the second content item are of different content types.

20. The system of claim 16, wherein the content holding application window displays a third content item, and the first and second content items are selected within the content holding application window.
